(19) United States
(12) Patent Application Publication
(10) Pub. No.: US 2024/0057623 A1
(43) Pub. Date: Feb. 22, 2024

(54) ROTATABLE MANDREL

(71) Applicant: Foodmate B.V., Numansdorp (NL)

(72) Inventors: David Scott Hazenbroek, Mijnsheerenland (NL); Adrianus Cornelis Johannes Hoppenbrouwers, Halsteren (NL)

(21) Appl. No.: 18/267,287

(22) PCT Filed: Dec. 16, 2021
(86) PCT No.: PCT/NL2021/050769

§ 371 Date: Jun. 14, 2023

(30) Foreign Application Priority Data
Dec. 16, 2020 (NL) 2027125

(51) Int. Cl. A22C 21/00; B65G 23/40; B65G 17/12

(52) U.S. Cl. CPC A22C 21/0053; B65G 23/40; B65G 17/12; B65G 2201/0202

(57) ABSTRACT

A poultry conveying system includes: an endless conveyor including a connection block; a mandrel for supporting a poultry carcass or a part thereof; an intermediate section having a first end and a second end, the first end connecting to the mandrel and the second end connecting to the connection block, wherein the mandrel is arranged for rotating at the first end of the intermediate section around a first axis and around a second axis at a non-zero angle relative to the first axis; and a first actuator arranged for actuating the rotation of the mandrel around the first axis, and a second actuator arranged for actuating the rotation of the mandrel around the second axis, wherein the first actuator and the second actuator are located at the second end of the intermediate section.

### FIELD OF THE INVENTION

The invention relates to the processing of poultry carcasses. More specifically the invention relates to a way of guiding a poultry carcass through one or more processing steps.

### BACKGROUND TO THE INVENTION

In the processing of poultry carcasses it is known to have a carrier carry the poultry carcasses through one or more processing steps. These processing steps may include deskinning, deboning, cutting and harvesting of meat from the poultry carcasses or parts thereof.

An area of possible optimization within this field of application lies in the orientation of the poultry carcasses during one or more processing steps. It has been noted that for some processing steps a different orientation may be preferred than for other processing steps. Changing the orientation of the poultry carcasses is done in different ways. In some cases the orientation of the poultry is not changed at all. In other cases it is done manually, which is time consuming and costly. Automated methods exist, but these are often very complex and therefor also quite expensive, and often provide insufficient possibilities for orienting the poultry carcass.

### SUMMARY OF THE INVENTION

It is an object of the invention to provide a poultry conveying system, a poultry processing apparatus and a method to achieve automated orientation of a poultry carcass in numerous possible orientations to optimize possible processing steps applied to the poultry carcass.

According to an aspect is provided a poultry conveying system including an endless conveyor including a connection block. The poultry conveying system also includes a mandrel for supporting a poultry carcass or a part thereof. The poultry conveying system includes an intermediate section having a first end and a second end. The first end is connected to the mandrel. The second, e.g. opposite, end is connected to the connection block. The mandrel is arranged for rotating around a first axis and around a second axis, at a non-zero angle relative to the first axis. The poultry conveying system includes a first actuator arranged for actuating the rotation of the mandrel around the first axis. The poultry conveying system includes a second actuator arranged for actuating the rotation of the mandrel around the second axis. The first actuator and the second actuator are located at the second end of the intermediate section.

Thus, is provided a poultry conveying system having a mandrel that can be rotated around two different axes. Hence, the mandrel can be positioned into many different positions. The first axis can extend close to, such as through, the first end of the intermediate section. The second axis can extend close to, such as through, the first end of the intermediate section. The mandrel can be arranged for rotating at the first end of the intermediate section around the first axis and around the second axis. The first axis can extend longitudinally of the intermediate section. The second axis can extend at a non-zero angle relative to the longitudinal direction of the intermediate section. The second axis can extend perpendicular to the longitudinal direction of the intermediate section. The second axis can form a virtual axis of rotation. The second axis can e.g. be substantially perpendicular to the first axis, giving an intuitive approach to how the mandrel can reach a predetermined position based on two independent orthogonal rotations. The intermediate section can provide an offset distance between the connection block of the endless conveyor and the mandrel. Hence, the poultry carcass or part thereof can easily be positioned around the first axis and the second axis without colliding with the connection block or the remainder of the endless conveyor. The second axis forming a virtual axis of rotation can further aid in avoiding collision of the poultry carcass or part thereof with the intermediate section, the connection block or the remainder of the endless conveyor. The first actuator and the second actuator being located at the second end of the intermediate section provides the advantage that the rotation of the mandrel around the first axis and the second axis can be actuated from at or near the connection block. Hence, actuation can be performed in a very simple manner and out of the way of the mandrel.

Optionally, the first actuator is arranged for rotation about a first actuation axis and/or the second actuator is arranged for rotation about a second actuation axis. Rotational actuation can provide for a simple construction, e.g. using a Geneva drive wheel, such as a Maltese cross, at the first and/or second actuator. Optionally, the first actuator is arranged for rotation about a first actuation axis and the second actuator is arranged for rotation about a second actuation axis. In such case, both the first actuator and the second actuator can include a Geneva drive wheel. The first actuation axis can be parallel to the second actuation axis. Optionally, the first actuation axis coincides with the second actuation axis. This can provide for a simple construction. Optionally, the first and second actuation axes coincide with the first axis.

Optionally, the intermediate section includes a first relay element and a second relay element. Movement of the first relay element results in a rotation of the mandrel around the first axis. Movement of the second relay element results in a rotation of the mandrel around the second axis. The first relay element can include one or more of a shaft, a wire, a chain, a gear, a friction wheel, a lever, or the like. The second relay element can include one or more of a shaft, a wire, a chain, a gear, a friction wheel, a lever, or the like. The first relay element and the second relay element allow easy transmission of actuation from the second end of the intermediate section to the first end.

Optionally, the first relay element is, or includes, a first shaft and the second relay element is, or includes, a second shaft. Movement, such as rotation, of the first shaft can result in a rotation of the mandrel around the first axis. Movement, such as rotation, of the second shaft can result in a rotation of the mandrel around the second axis. This optional configuration of two separate shafts allows to simply independently control the rotation of the mandrel around two different axes.

Optionally, one of the first shaft and second shaft is a hollow shaft and the other one of the first shaft and the second shaft is an internal shaft extending through the hollow shaft. The hollow shaft and the internal shaft are arranged to move, such as rotate and/or translate, independently of each other, e.g. around a shared axis. This optional configuration results in a space saving, easy to construct mechanical construction allowing the independent control of rotation around two different axes. The first shaft can extend along the first actuation axis. The second shaft can extend along the second actuation axis.

Optionally, the first shaft is rigidly connected to the mandrel in order to transfer the rotational movement of the first shaft directly to the mandrel. This rigid connection is an easy way to achieve the transfer of rotation around the first axis to the mandrel. Optionally, the first shaft is connected to the mandrel through a transmission, such as a gear set. The transmission can be arranged to transfer the rotational movement of the first shaft around a longitudinal axis of the first shaft to rotation of the mandrel around the second axis. The transmission can e.g. include shafts, wires, chains, a gear set, such as a crown gear set, friction wheels, levers, or the like.

Optionally, the second shaft is connected to the mandrel through a transmission, such as a gear set. The transmission can be arranged to transfer the rotational movement of the second shaft around a longitudinal axis of the second shaft to rotation of the mandrel around the second axis. The transmission, such as the gear set, allows for a change of axis of rotation. The transmission can e.g. include shafts, wires, chains, a gear set, such as a crown gear set, friction wheels, levers, or the like.

Optionally, the first shaft is arranged to translate in a longitudinal direction thereof. The first shaft can be connected to the mandrel such as to convert the translational movement into a rotation of the mandrel.

Optionally, the first axis is substantially perpendicular to the endless conveyor, e.g. perpendicular to the connection block. This optional configuration allows a more intuitive control of the rotation of the mandrel.

Optionally, the first actuator and/or the second actuator includes a Geneva drive wheel, such as a Maltese cross. A Geneva drive provides an easy way to create a fully mechanical, automated way to achieve a rotation over a certain predetermined angle, such as 90 degrees. Also, use of Geneva drive incremental rotational drives is common in poultry processing machinery. Optionally, both the first actuator and the second actuator include a Geneva drive wheel.

Optionally, a reducing transmission is placed between the first actuator and the mandrel and/or between the second actuator and the mandrel. Thus, e.g. rotation of the first and/or second actuator results in a reduced rotation of the mandrel around the first and/or second axis. For example, rotation of the first and/or second actuator can be reduced by a factor of 1.5, 2, 3, 4, 6, or any other suitable number Thus, it can be easily be achieved that rotation of the first and/or second actuator over 90 degrees results in a rotation of the mandrel around the first and/or second axis over 60, 45, 30, 22.5, or 15 degrees, respectively, or any other suitable angle increment.

Optionally, the first actuator and/or the second actuator includes an electric motor. Hence, rotation of the mandrel around the first and/or second axis can easily be controlled.

Optionally, the poultry conveying system includes a holding system for the first actuator and/or the second actuator. The holding system is arranged to selectively be in a first mode or a second mode. In the first mode, the holding system prevents the respective actuator from actuating. In the second mode, the holding system allows the respective actuator to actuate. The main advantage of the holding system is to prevent unwanted rotation of the mandrel.

Optionally, the holding system is arranged for in the first mode blocking rotation of the respective actuator such as a first Geneva drive block and/or second Geneva drive block, and in the second mode releasing the respective actuator for rotation. Hence, simple prevention of undesired actuation can be provided.

Optionally, the first actuator is arranged for actuating the rotation of the mandrel simultaneously around the first and second axes when the holding system of the second actuator is in the second mode and/or the second actuator is arranged for actuating the rotation of the mandrel simultaneously around the first and second axes when the holding system of the first actuator is in the second mode. This optional configuration allows the poultry conveying system to rotate the mandrel around the first and the second axis simultaneously using only one of the actuators, thus allowing the mandrel to achieve a required orientation with less actuation steps.

Optionally, the holding system is arranged to be locked in the first mode by application of a locking force. Optionally, the holding system is arranged to be unlocked in the first mode by application of an unlocking force. Introducing a force needed for locking and unlocking prevents unwanted locking and unlocking of the holding system.

Optionally, a first guiding rail is included. The first guiding rail is arranged to apply the locking force. Optionally, a second guiding rail is included. The second guiding rail is arranged to apply the unlocking force. The two guiding rails offer a simple, mechanical means to apply the locking and unlocking force at predetermined points along the endless conveyor of the poultry conveying system.

Optionally, one or more inputs are included. The inputs are arranged to actuate the actuators from a first predetermined position to a second predetermined position. These inputs allow for a planned actuation of the actuators. The inputs can e.g. include one or more turning pins of a Geneva drive.

Optionally, the holding system is biased to the first mode. This prevents the actuator to perform unwanted actuations, for example when the system is not in operation.

Optionally, the mandrel includes a carcass retainer. The carcass retainer is arranged to keep the poultry carcass or a part thereof fixed to the mandrel. The retainer can e.g. include a gripper for gripping a part of the poultry carcass. The retainer allows for easy manual or automated attachment to the mandrel and easy manual or automated detachment from the mandrel of the poultry carcass or a part thereof.

Optionally, the endless conveyor is an articulated endless conveyor.

It will be appreciated that the endless conveyor of the poultry conveying system can include a plurality of connection blocks. Each connection block can be connected to an associated mandrel as described hereinabove. Hence, the poultry conveying system can include a plurality of mandrels, each rotatable around a first axis and a second axis.

According to an aspect is provided a poultry processing apparatus. The poultry processing apparatus includes the poultry conveying system described hereinabove. The poultry conveying system can include a plurality of the mandrels rotatable around two axes. The poultry processing apparatus also includes one or more processing stations arranged for processing the poultry carcass or part thereof, for example by cutting, skinning, deboning or harvesting. The poultry processing apparatus provides the advantage that a poultry carcass can be orientated in an automated way optimized for each processing station. A convenient orientation in which automatic or manual placement of a poultry carcass onto the mandrel of the poultry processing system is provided is also envisioned.

According to an aspect is provided a method for conveying a poultry carcass or a part thereof. The method includes placing the poultry carcass or a part thereof on a mandrel connected to a connection block of a conveying system via an intermediate section. The method includes rotating the mandrel around a first axis relative to the intermediate section by actuating a first actuator located at or near the connection block. The method includes rotating the mandrel around a second axis relative to the intermediate section by actuating a second actuator located at or near the connection block.

Optionally, actuating the first actuator includes rotating the first actuator about a first actuation axis. Optionally, actuating the second actuator includes rotating the second actuator about a second actuation axis. The first actuation axis can be parallel to the second actuation axis. Optionally, the first actuation axis coincides with the second actuation axis. Optionally, the first and second actuation axes coincide with the first axis.

Optionally, the method includes rotating the mandrel around the first axis by moving a first relay element of the intermediate section, and rotating the mandrel around the second axis by moving a second relay element of the intermediate section.

Optionally, the method includes rotating the mandrel around the first axis by rotating a first shaft of the intermediate section, and rotating the mandrel around the second axis by rotating a second shaft of the intermediate section.

Optionally, the first actuator and/or the second actuator includes a Geneva drive wheel, such as a Maltese cross.

Optionally, the first actuator and/or the second actuator includes an electric motor.

Optionally, the method includes operating a holding system for the first actuator and/or the second actuator, wherein the holding system is operated to selectively be in a first mode or a second mode, wherein in the first mode the holding system prevents the respective actuator from actuating, and in the second mode the holding system allows the respective actuator to actuate.

Optionally, the method includes selectively locking the holding system in a first mode by application of a locking force, and selectively unlocking the holding system by application of an unlocking force.

Optionally, the method includes conveying the poultry carcass or part thereof past one or more processing stations arranged for processing the poultry carcass or part thereof such as by cutting, skinning, deboning or harvesting.

It will be appreciated that all features and options mentioned in view of the poultry conveying system apply equally to the poultry processing apparatus and method, and vice versa. It will also be clear that any one or more of the above aspects, features and options can be combined.

### BRIEF DESCRIPTION OF THE DRAWINGS

Embodiments of the present invention will now be described in detail with reference to the accompanying drawings in which:

FIG. 1 shows a top view of a schematic example of a mandrel module of a poultry conveying system;

FIGS. 2A and 2B show a front view of a schematic example of an actuation block and a holding system of the poultry conveying system of FIG. 1, in a first mode and in a second mode respectively;

FIG. 3 illustrates the working principle of the actuation block and holding system illustrated in FIGS. 2A and 2B;

FIG. 4 shows a top view of a schematic example of a poultry processing apparatus, including a plurality of the mandrel modules shown in FIG. 1;

FIG. 5 shows a top view of a schematic example of a poultry processing apparatus, including a plurality of the mandrel modules shown in FIG. 1;

FIG. 6 shows a side view of a schematic example of a mandrel module of a poultry conveying system

FIG. 7 shows a side view of a schematic example of a mandrel module of a poultry conveying system;

FIG. 8 shows a side view of a schematic example of a mandrel module of a poultry conveying system; and

FIG. 9 shows a top view of a schematic example of a poultry processing apparatus, including a plurality of the mandrel modules shown in FIG. 1.

### DETAILED DESCRIPTION

The invention is described more fully hereinafter with reference to the accompanying drawings, in which examples are shown. This invention may, however, be embodied in many different forms and should not be construed as limited to the examples set forth herein. Rather, these examples are provided so that this disclosure will be thorough and complete, and will fully convey the scope of the invention to those skilled in the art.

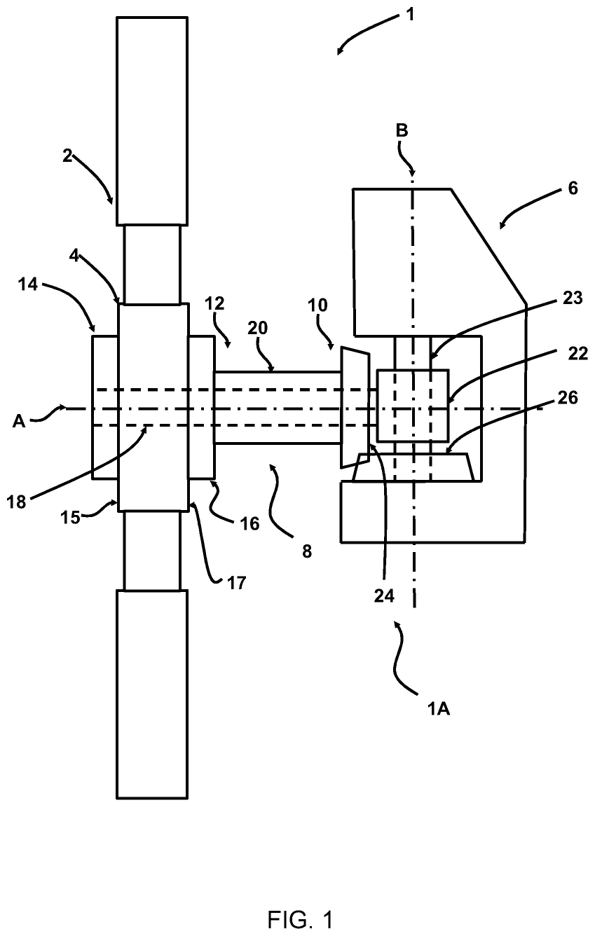

FIG. 1 shows a schematic example of a mandrel module 1A of a poultry conveying system 1. The mandrel module 1A includes a connection block 4, e.g. of an endless conveyor 2. The mandrel module 1A includes a mandrel 6 for attaching a poultry carcass thereto. Said mandrel 6 is arranged to carry a poultry part or a part thereof. Here, the mandrel 6 is connected to the connection block 4 via an intermediate section 8. The intermediate section 8 has a first end 10 connecting the mandrel 6 to the intermediate section 8 and a second end 12 connecting the intermediate section 8 to the connection block 4. The mandrel 6 is arranged for rotating, here at the first end 10 of the intermediate section 8, around a first axis A and around a second axis B. In this example the first axis extends longitudinally of the intermediate section 8. In this example, the first axis A is perpendicular to the second axis B. The mandrel module 1A includes a first actuator 14 arranged for actuating the rotation of the mandrel 6 around the first axis A. The mandrel module 1A includes a second actuator 16 arranged for actuating the rotation of the mandrel 6 around the second axis B. Here, the first actuator 14 and second actuator 16 are located at the second end 12 of the intermediate section 8. In this example, the first actuator 14 is positioned at a first side 15 of the connection block 4 and the second actuator 16 is positioned at a second, opposite side 17 of the connection block 4. Here, the first actuator 14 is arranged for rotation about a first actuation axis and the second actuator 16 is arranged for rotation about a second actuation axis. In this example, the first actuation axis coincides with the second actuation axis. More particularly, here the first and second actuation axes coincide with the first axis A. More in general, the first actuation axis and the second actuation axis can be parallel or non-parallel.

In FIG. 1 the intermediate section 8 includes a first relay element 18 for relaying actuation of the first actuator 14 to rotation of the mandrel 6 around the first axis A. The intermediate section 8 further includes a second relay element 20 for relaying actuation of the second actuator 16 to rotation of the mandrel 6 around the second axis B. In the example displayed in FIG. 1 the second relay 20 element is a hollow shaft 20 and the first relay element 18 is a center shaft 18 extending through the hollow shaft 20. In this example, the center shaft 18 and the hollow shaft 20 are concentric. Here, the center shaft 18 and the hollow shaft 20 are rotatable relative to the connection block 4.

In the example illustrated in FIG. 1, the rotation of the center shaft 18 is transferred to the mandrel 6 through a rigid connection to a rotation block 22. Here, the rotation block 22 receives an axle 23 allowing the mandrel 6 to rotate around the second axis B relative to the rotation block 22. It will be appreciated that the axle 23 can be rotatably received in the rotation block 22 and/or in the mandrel 6. In this example, the rotation of the hollow shaft 20 is transferred to the mandrel 6 through a bevel gear set including a first bevel gear 24 and a second bevel gear 26. Here, the first bevel gear 24 is rotationally fixed relative to the hollow shaft 20. Here, the second bevel gear 26 is rotationally fixed relative to the mandrel 6.

In FIG. 1 the first actuator 14 is a first actuation block, such as a Geneva drive wheel. Here, the first actuation block 14 is rotationally fixed relative to the center shaft 18. In FIG. 1 the second actuator 16 is an second actuation block, such as a Geneva drive wheel. Here, the second actuation block 16 is rotationally fixed relative to the hollow shaft 20.

When the first actuation block 14 is rotated, rotation thereof is relayed to rotation of the rotation block 22 around the first axis A. Hence, the orientation of the axle 23 can be rotated around the first axis A. Hence, the mandrel 6 connected to the axle 23 can be rotated around the first axis A.

When the second actuation block 16 is rotated, rotation thereof is relayed to rotation of the first bevel gear around the first axis A. Rotation of the first bevel gear 24 around the first axis A is relayed to rotation of the second bevel gear 26 around the second axis B. Hence, the mandrel 6 connected to the second bevel gear 26 can be rotated around the second axis B.

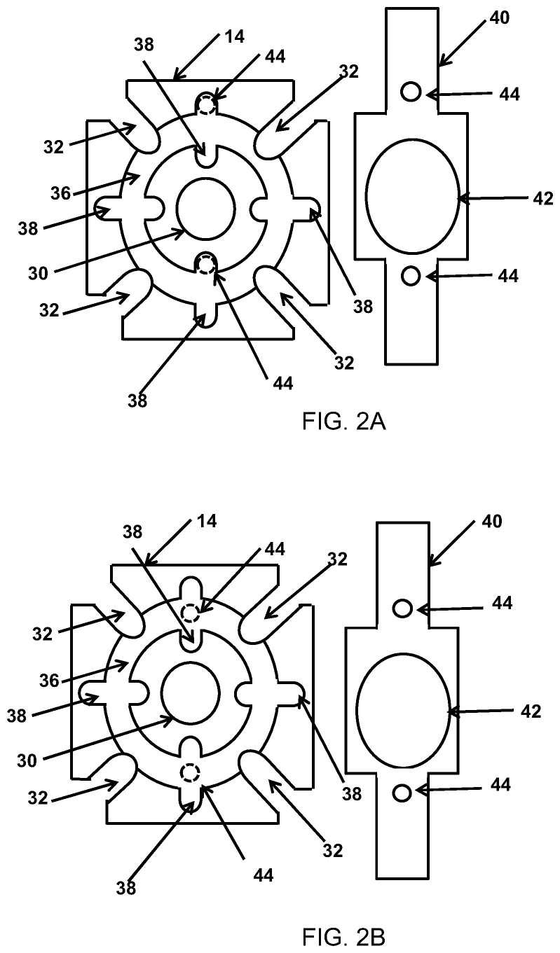

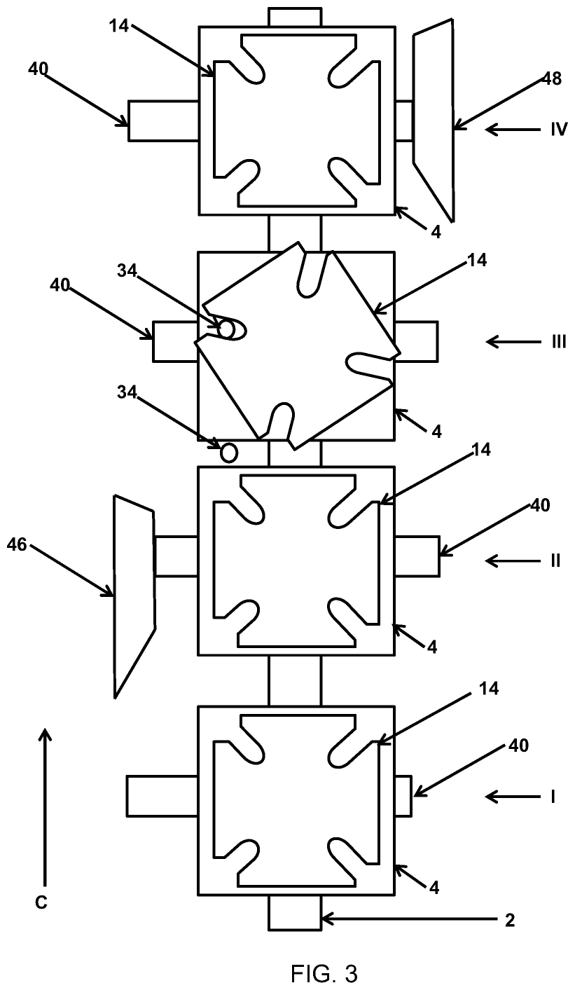

FIGS. 2A and 2B show a detail of the first actuator 14 of FIG. 1. In this example the first actuation block 14 is a Geneva drive wheel. More specifically the Geneva drive wheel 14 is a Maltese cross. The Maltese cross 14 is rotationally fixed to the center shaft 18 at the center hole 30. The center shaft 18 not shown here. The Maltese cross 14 has four rotation recesses 32. These rotation recesses are arranged to 32 receive the rotation pin 34 shown in FIG. 3. In this example, the Maltese cross 14 also has a circular recess 36 with four holding recesses 38. In this example, each holding recess 38 extends both radially inside and radially outside the circular recess 36. The use hereof is explained hereafter. Next to the Maltese cross 14 a holding system 40 is presented. The holding system 40 has an elongate hole 42 to allow the center shaft 18 to pass through the holding system 40. Here, the holding system 18 has two holding pins 44. The holding pins 44 move in the circular recess 36 and the four holding recesses 38 of the Maltese cross 14. The holding system 40 can be in a first mode or in a second mode. In FIG. 2A the first mode is illustrated. The holding pins 44 are positioned in two of the four holding recesses 38. In the first mode rotation of the Maltese cross 14 prevented. In FIG. 2B the second mode is illustrated. The holding pins 44 are positioned in the circular recess 36. In the second mode rotation of the Maltese cross 14 is allowed. To move the holding system 40 from the first mode illustrated in FIG. 2A to the second mode illustrated in FIG. 2B, a unlocking force can be applied. To move the holding system 40 from the second mode illustrated in FIG. 2B to the first mode illustrated in FIG. 2A, a locking force can be applied. In this example, in the first mode the holding pins 44 are positioned in the upper ends of the holding recesses 38. It will be appreciated that in this example, the holding system 40 can be in a third mode in which the holding pins 44 are positioned in the lower ends of the holding recesses 38. The holding system 40 can be in the third mode in addition to the first mode, or instead of the first mode.

FIG. 3 shows an example of a plurality of Maltese crosses 14 attached to a plurality of connection blocks 4 connected by an endless conveyor 2. Moving in the direction C the Maltese cross 14 is depicted at the bottom of FIG. 3 at a first position I, with the holding system 40 in the first mode. When moving in the direction C, the holding system 40, at about position II, encounters a first guiding rail 46. Here, the first guiding rail 46 applies an unlocking force to the holding system 40, putting the holding system 40 in the second mode. Moving on in the direction C, the Maltese cross 14, between positions II and III, encounters a rotation pin 34, which, in this example, actuates the Maltese cross over a 90° counterclockwise turn around the first axis A (at position III partial rotation is shown). Hence, resulting in a 90° counterclockwise turn of the center shaft 18 around first the axis A. Hence, resulting in a 90° counterclockwise turn of the mandrel 6 around the first axis A. Moving on in the direction C, at about position IV, the Maltese cross 14 encounters a second guiding rail 48 on the opposite side of the Maltese cross 14 in comparison to the first guiding rail 46. The second guiding rail 48 applies a locking force on the holding system 40. The holding system 40 is once again put in the first mode.

FIGS. 2A, 2B and 3 depict the side of the first actuation block 14 and the center shaft 18. It will, however, be appreciated that the descriptions offered with these figures are also applicable on the second actuation block 16 concerning the hollow shaft 20.

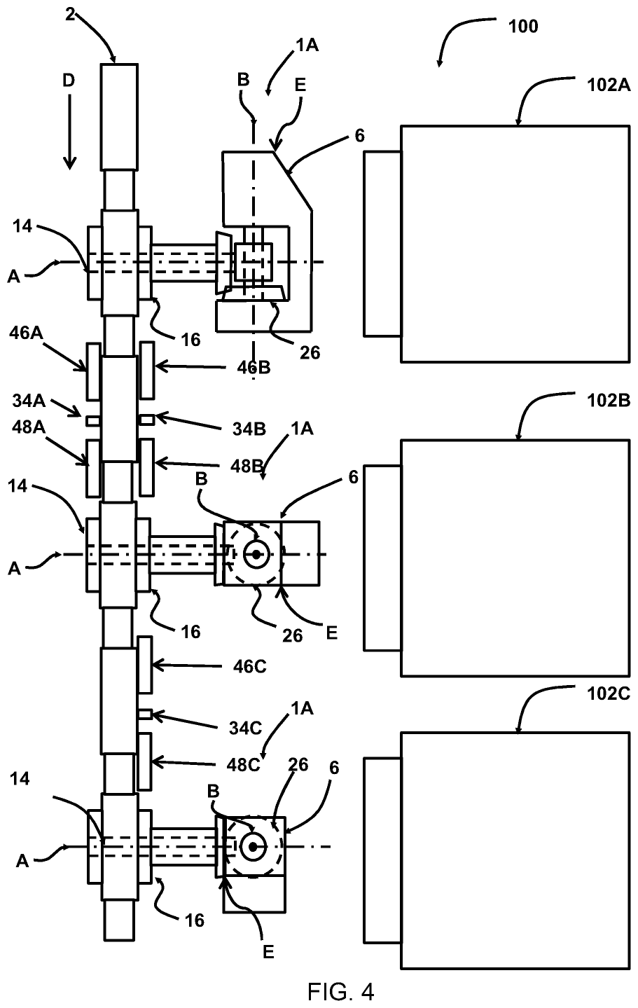

FIG. 4 shows an example of a poultry processing apparatus 100. In FIG. 4, the endless conveyor 2 includes a plurality of mandrel modules 1A as described in relation to FIG. 1. In this example the apparatus 100 further includes a plurality of processing stations 102A, 102B, 102C positioned along the endless conveyor 2. A processing station 102A, 102B, 102C can, for example but not exclusively, be a skinning station, a deboning station, a cutting station or a harvesting station. In the embodiment illustrated in FIG. 4, the first actuator 14 and second actuator 16 are Maltese crosses as illustrated in FIGS. 2A, 2B and 3. For clarity, the terms first actuator 14 and second actuator 16 will be used in the description of FIG. 4.

In use, the mandrels 6 can be moved along a conveying path associated with the endless conveyor 2. In the embodiment illustrated in FIG. 4, the mandrels 6 pass three processing stations 102A, 102B, 102C in a moving direction D.

In between the processing stations 102A and 102B the first actuator 14 passes a first guiding rail 46A which puts the holding system 40 in the second mode, allowing rotation of the first actuator 14. Also in between the processing stations 102B and 102C the second actuator 16 passes a first guiding rail 46B which puts the holding system 40 of the second actuator 16 in the second mode, allowing rotation of the second actuator 16. The holding systems 40 are not displayed in FIG. 4 for clarity. Afterwards the first actuator 14 passes a rotation pin 34A which actuates the first actuator 14. In this example the first actuator 14 is rotated 90° around the first axis A. Also the second actuator 16 passes a rotation pin 34B which actuates the second actuator 16. In this example the second actuator 16 is rotated 90° around the first axis A in the same direction as the first actuator 14. As a result, both the hollow shaft 20 and the center shaft 18 rotate over 90 degrees in the same direction, resulting in the mandrel 6 turning 90° around the first axis A. After the rotation the first actuator 14 passes a second guiding rail 48A which puts the holding system 40 of the first actuator 14 in the first mode. The second actuator 16 passes a second guiding rail 48B which puts the holding system 40 of the second actuator 16 in the first mode.

In between the processing stations 102B and 102C the second actuator 16 passes a first guiding rail 46C which puts the holding system 40 of the second actuator 16 in the second mode, allowing rotation of the second actuator. Afterwards the second actuator 16 passes a rotation pin 34C which actuates the second actuator 16. In this example the second actuator 16 is rotated 90° around the first axis A resulting in the mandrel turning 90° around the second axis B. After the rotation the second actuator 16 passes a second guiding rail 48C which puts the holding system 40 of the second actuator 16 in the first mode.

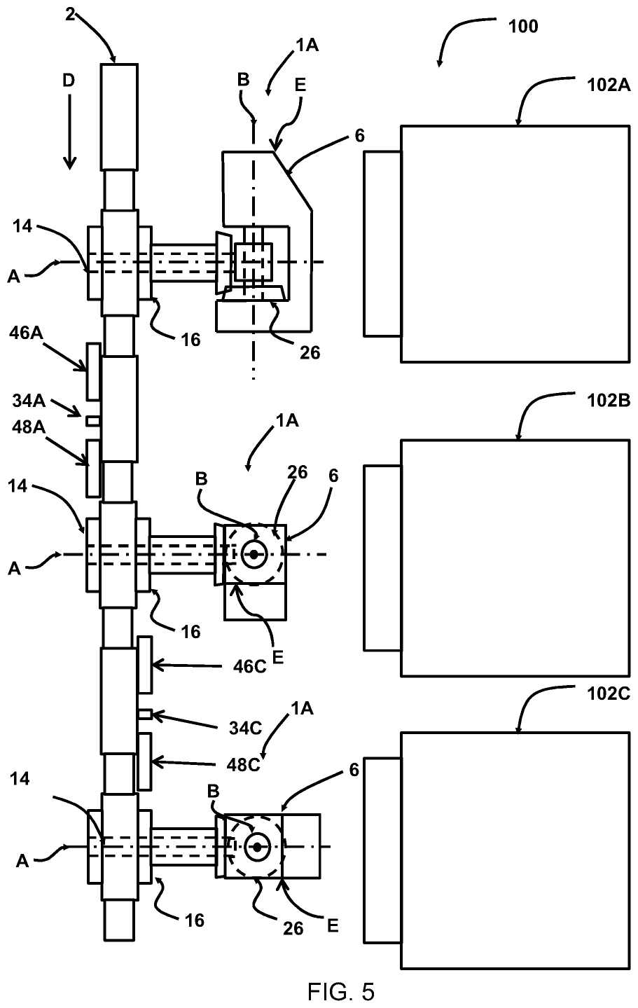

FIG. 5 shows an example of a poultry processing apparatus 100 as shown in FIG. 4. In the embodiment illustrated in FIG. 5, the mandrels 6 pass three processing stations 102A, 102B, 102C in a moving direction D.

In between the processing stations 102A and 102B the first actuator 14 passes a first guiding rail 46A which puts the holding system 40 of the first actuator 14 in the second mode, allowing rotation of the first actuator 14. In the example of FIG. 5, the holding system 40 of the second actuator 16 remains in the first mode, preventing rotation of the second actuator. The holding systems 40 are not displayed in FIG. 5 for clarity. Afterwards the first actuator 14 passes a rotation pin 34A which actuates the first actuator 14. In this example the first actuator 14 is rotated 90° around the first axis A. As a result, only the center shaft 18 rotates over 90 degrees, resulting in the mandrel 6 turning 90° around the first axis A and the first axis B simultaneously. After the rotation the first actuator 14 passes a second guiding rail 48A which puts the holding system 40 of the first actuator 14 in the first mode.

In between the processing stations 102B and 102C the second actuator 16 passes a first guiding rail 46C which puts the holding system 40 of the second actuator 16 in the second mode, allowing rotation of the second actuator. Afterwards the second actuator 16 passes a rotation pin 34C which actuates the second actuator 16. In this example the second actuator 16 is rotated 90° around the first axis A resulting in the mandrel turning 90° around the second axis B. After the rotation the second actuator 16 passes a second guiding rail 48C which puts the holding system 40 of the second actuator 16 in the first mode.

Hence, it will be appreciated that, rotation around the first axis A and around the second axis B can be actuated separately or simultaneously.

It will also be appreciated that the poultry processing apparatus 1 can be arranged such that the first actuator 14 is arranged for actuating the rotation of the mandrel 6 around the first axis A and the second axis B simultaneously when the holding system 40 of the second actuator 16 is in the second mode and/or wherein the second actuator 16 is arranged for actuating the rotation of the mandrel 6 around the first axis A and the second axis B simultaneously when the holding system 40 of the first actuator 14 is in the second mode. The center shaft 18 and the hollow shaft 20 can for example be arranged to rotate together with another when one of the two shafts 18, 20 is rotated by one of the two actuators 14, 16. The poultry processing apparatus 1 can for example be arranged as such that the actuators 14, 16 pass the first guiding rail 46 which applies an unlocking force to unlock the holding system 40 now releasing both the first actuator 14 and the second actuator 16. Both actuators 14, 16 can now be rotated by a rotation pin 34. The first actuator 14 can for example pass a rotation pin 34 causing the first actuator 14 to rotate over 90° around the first axis A, causing the mandrel 6 to rotate 90° around the first axis A. The first actuator 14 also causes the hollow shaft 20 to rotate over 90° around the first axis A, causing the mandrel 6 to rotate over 90° around the second axis B. This optional configuration allows the poultry conveying system to rotate the mandrel around the first and the second axis simultaneously using only one of the actuators, thus allowing the mandrel to achieve a required orientation with less actuation steps.

The mandrel point E displays the rotation of the mandrel 6 in between the processing steps.

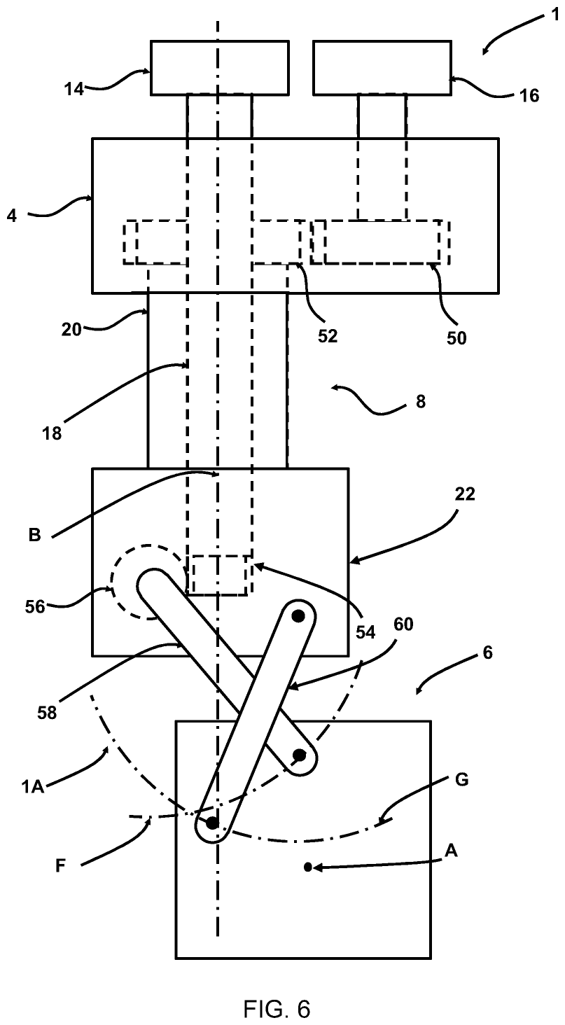

FIG. 6 shows a cross sectional front view of a schematic example of a mandrel module of a poultry conveying system. FIG. 6 shows an example of a mandrel module 1 wherein the first actuator 14 and the second actuator 16 include electric motors instead of Geneva drive wheels. As opposed to the example described hereinabove, both the first electric motor 14 and the second electric motor 16 are arranged at the same side of the connection block 4. The second electric motor 16 is connected to the second relay element 20, here hollow shaft 20, through a, in this example, gear set comprising a first gear 50 and a second gear 52. In this embodiment, the hollow shaft 20 is rigidly connected to the rotation block 22. A rotational movement provided by the second electric motor 16 is passed on through the gear set, through the hollow shaft 20 to the rotation block 22, causing the mandrel 6 to rotate around the second axis B. The gear set is shown in a schematic matter. It shall be clear that variants relating to the gear ratio of the gear set or to the amount of gears comprised by the gear set are possible. The gear ratio may preferable be chosen such that a relatively light electric motor is sufficient to rotate the possibly relatively heavy mandrel 6, optionally with a relatively heavy poultry part carried thereon. The amount of gears may be chosen such that the mandrel 6 rotates in the same or opposite direction as the second electric motor 16. Optionally, the first actuator 14 and/or the second actuator 16 includes a first encoder and/or a second encoder, respectively. The first and/or second encoder can be used for simplifying positioning the mandrel to a desired position, e.g. when using the first and/or second electric motor.

The first electric motor 14 is, in this example, connected directly to the first relay element 18, here center shaft 18. The center shaft 18 extends through the hollow shaft 20 and is rotatably received in the rotation block 22. The center shaft 18 is connected to the mandrel 6 by a transmission. In this example, the transmission includes a worm gear set comprising a worm 54 and a worm gear 56. It shall be appreciated that variants regarding the gear set described above also apply to the worm gear set. The transmission further comprises a first beam 58, rigidly connected to the worm gear 56, wherein the first beam 58 is rotatably connected to the mandrel 6. The transmission further comprises a second beam 60, wherein the second beam is rotatably connected to the rotation block 22 at one end, and is rotatably connected to the mandrel 6 at an other end. As such, a rotational movement provided by the first electric motor 14 is passed on by the center shaft 18 through the worm gear set 54, 56, causing the first beam 58 to rotate around the rotational axis of the worm gear 56. The end of the first beam 58 connected to the mandrel 6 therefore moves along a first circular path F. The mandrel 6 moves along with the first beam 58, but this movement is restricted by the second beam 60, as the end of the second beam 60 connected to the mandrel 6 can only move along circular path G. The rotation of the first beam 58 in combination with the restriction of the second beam 60 cause the mandrel 6 to rotate around a virtual first axis A. The virtual first axis A is shown here at a specific location, but it shall be clear that the exact position of the virtual axis A changes as the mandrel 6 rotates around the virtual first axis A.

Based on the above, it can be said that example shown in FIG. 6 is different from the example shown in FIGS. 1, 2, 3, 4 and 5 regarding two aspects. A first difference is the use of electric motors instead of Geneva drive wheels. The advantages of the Geneva drive wheel notwithstanding, using an electric motor may provide for a simpler construction of the poultry processing apparatus 100 as a whole, as the guiding rails and rotation pins can be replaced by an electrical circuit arranged to operate the electric motors. This electrical circuit might also be easier to reprogram, for example in response to an adjustment to the processing station. The guiding rails and rotation pins would require mechanical interventions to the processing apparatus to achieve the same. A second difference is the connection between the rotation block and the mandrel. The combination of the first beam 58 and the second beam 60 cause the mandrel 6 to rotate about a virtual first axis A instead of about a fixed axis. An advantage of rotation about a virtual axis is that the mandrel may require a lesser volume in which all possible orientations of the mandrel can be achieved. As such, the processing apparatus can be made more compact.

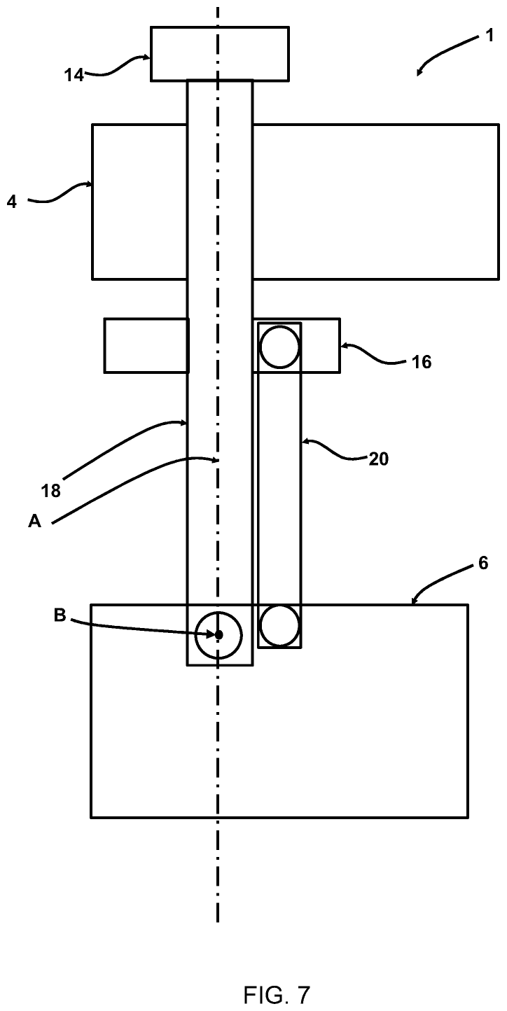

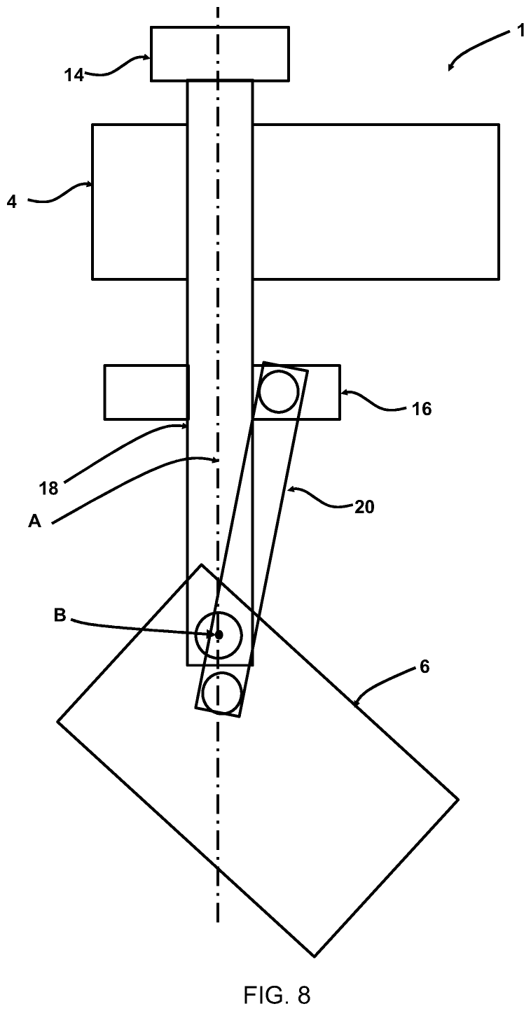

FIG. 7 and FIG. 8 show a view of a schematic example of a mandrel module of a poultry conveying system. FIG. 7 shows an example of a mandrel module 1 wherein the second actuator 16 is arranged to provide a translational movement. The second actuator 16 is shown here as a actuating disc 16 arranged around the center shaft 18 such that the actuating disc 16 can translate with regards to the center shaft 16. A guiding rail, similar to the guiding rails 46 described hereinabove, may be provided to translate the guiding disc 16 along the center shaft 18. The guiding disc 18 is hingedly connected to the second relay element 20, shown here as a beam 20. The beam 20 is hingedly connected to the mandrel 6. The mandrel 6 is also hingedly connected to the center shaft 18. A translational movement of the guiding disc 18, for example caused by a guiding rail, is transferred through the beam 20 to the connection between the beam 20 and the mandrel 6, causing the mandrel to rotate around second axis B. Rotation of the first actuator 14 is transferred directly onto the mandrel 6 through the center shaft 18, and causes the mandrel 6 to rotate around the first axis A. FIG. 8 shows the example of FIG. 7 wherein the guiding disc 18 is translated towards the mandrel 6.

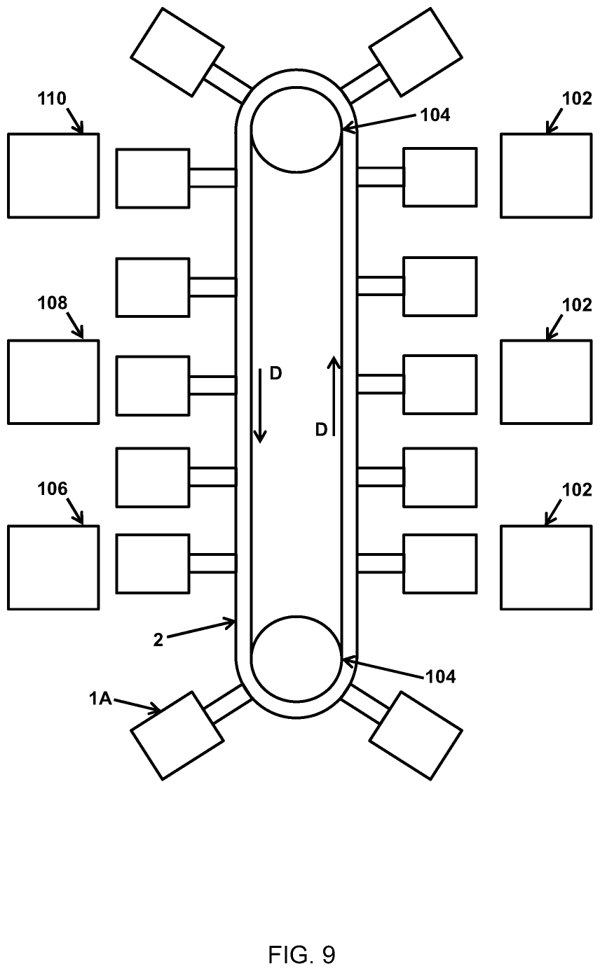

FIG. 9 shows a top view of a schematic example of a poultry processing apparatus, including a plurality of the mandrel modules 1A shown in FIG. 1. FIG. 9 shows an endless conveyor 2 moving around turn points 104 in the moving direction D. One or both of the turn points 104 can, but not necessarily, be driven by a motor. In FIG. 9, the endless conveyor 2 is shown as moving around two turn points 104 where the moving direction D turns over 180° at each turn point 104. It will however be appreciated that more than two turn points 104 can be present, where the moving direction D can turn over any angle. The endless conveyor 2 includes a plurality of mandrel modules 1A. A loading station 106 is shown near the endless conveyor 2. At the loading station 106, a poultry carcass or part thereof is mounted on the mandrel 6 of the mandrel module 1A. The loading station 106 can be an automated loading station 106 or a manual loading station 106. The rotation of the mandrel 6 is not shown in FIG. 9. The mandrel 6 can, at the loading station 106, be oriented as to facilitate the loading of the poultry carcass or part thereof thereto. The mandrel 6 can, for example, be oriented such that a poultry carcass or part thereof can be simply hung on a carcass retainer of the mandrel 6. The conveyor 2 then carries the mandrel 6 with the poultry carcass or a part thereof mounted thereon along several processing stations 102 according to FIGS. 4 and 5. The possible rotation of the mandrel 6 before and/or between processing stations 102 is not shown. Optionally, an unloading station 110 can be placed along the conveyor 2 after a last processing station 102. At the unloading station 110, a remainder of the poultry carcass or part thereof can be removed from the carcass retainer of the mandrel 6. The unloading station 110 can be an automated unloading station 110 or a manual unloading station 110. The mandrel 6 can, at the unloading station 110, be oriented as to facilitate the unloading of the remainder of the poultry carcass or part thereof. Optionally, a cleaning station 108 can be positioned between the unloading station 110 and the loading station 106. The mandrel 6 can be manually or automatically cleaned at the cleaning station 108 before receiving a new poultry carcass or part thereof at the loading station 106 as, for example, to prevent contamination.

Herein, the invention is described with reference to specific examples of the invention. It will, however, be evident that various modifications and changes may be made therein, without departing from the essence of the invention. For the purpose of clarity and a concise description features are described herein as part of the same or separate examples, however, alternative examples having combinations of all or some of the features described in these separate examples are also envisaged.

In the examples the first axis is perpendicular to the second axis. However, it will be appreciated that it is also possible that the first axis makes a different, non-zero angle with the second axis.

In the examples the movement of the actuation blocks is relayed to the mandrel via two concentric shafts, a rigid connection and a bevel gear set. However, it will be appreciated that it is also possible to relay the movement of the actuation blocks to the mandrel via one or more wires, ropes, cables, Bowden cables, one or more levers, hydraulic pumps, an electromagnetic connection or the likes.

In the example of FIG. 7 the first actuator and the second actuator include electric motors. It will be appreciated that it is also possible that the example of FIG. 7 is modified such that the first actuator and/or the second actuator includes a Geneva drive wheel. In the example of FIGS. 1, 2, 3, 4 and 5 the first actuator and the second actuator include a Geneva drive wheel. It will be appreciated that it is also possible that the example of FIG. 1, 2, 3, 4 or 5 is modified such that the first actuator and/or the second actuator includes an electric motor. It will be appreciated that in the example of FIGS. 8 and 9 the first actuator and/or the second actuator can include an electric motor and/or a Geneva drive wheel.

However, other modifications, variations, and alternatives are also possible. The specifications, drawings and examples are, accordingly, to be regarded in an illustrative sense rather than in a restrictive sense.

For the purpose of clarity and a concise description features are described herein as part of the same or separate embodiments, however, it will be appreciated that the scope of the invention may include embodiments having combinations of all or some of the features described.

In the claims, any reference sign placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A poultry conveying system including:
an endless conveyor including a connection block;
a mandrel configured for supporting a poultry carcass or a part thereof;
an intermediate section having a first end and a second end, the first end connecting to the mandrel and the second end connecting to the connection block, wherein the mandrel is configured to rotate around a first axis, and rotate around a second axis at a substantially non-zero angle relative to the first axis; and
a first actuator arranged for actuating the rotation of the mandrel around the first axis, and a second actuator arranged for actuating the rotation of the mandrel around the second axis,
wherein the first actuator and the second actuator are located adjacent to the second end of the intermediate section.

2. (canceled)

3. The poultry conveying system of claim 1, wherein the first actuation axis is substantially parallel to the second actuation axis.

4. The poultry conveying system of claim 1, wherein the intermediate section includes a first relay element and a second relay element, wherein movement of the first relay element results in rotation of the mandrel around the first axis, and wherein movement of the second relay element results in rotation of the mandrel around the second axis.

5. The poultry conveying system of claim 4, wherein the first relay element includes a first shaft and the second relay element includes a second shaft, wherein movement of the first shaft results in the rotation of the mandrel around the first axis, and wherein movement of the second shaft results in the rotation of the mandrel around the second axis.

6. The poultry conveying system of claim 5, wherein one of the first shaft and the second shaft comprises a hollow shaft and another one of the first shaft and the second shaft comprises an internal shaft extending through the hollow shaft, wherein the hollow shaft and the internal shaft are configured to move independently of each other.

7. (canceled)

8. The poultry conveying system of claim 5, wherein the second axis is substantially perpendicular to the first axis.

9. The poultry conveying system of claim 5, wherein the second axis forms a virtual axis of rotation.

10. The poultry conveying system of claim 5, wherein the first shaft is connected to the mandrel via a rigid connection, wherein the rigid connection is configured to transfer rotation of the first shaft to the mandrel to cause the rotation of the mandrel around the first axis.

11. The poultry conveying system of claim 5, wherein the first shaft is connected to the mandrel through a transmission, wherein the transmission is configured to transfer rotation of the first shaft to the mandrel to cause the rotation of the mandrel around the first axis.

12. The poultry conveying system of claim 5, wherein the second shaft is connected to the mandrel through a transmission, wherein the transmission is configured to transfer rotation of the second shaft to the mandrel to cause the rotation of the mandrel around the second axis.

13. The poultry conveying system of claim 1, wherein one of the first axis and the second axis is substantially perpendicular to the endless conveyor.

14. The poultry conveying system of claim 1, wherein at least one of the first actuator and the second actuator includes a Geneva drive wheel.

15. The poultry conveying system of claim 1, further comprising a reducing transmission positioned between the first actuator and the mandrel and/or between the second actuator and the mandrel.

16. The poultry conveying system of claim 1, wherein at least one of the first actuator and the second actuator includes an electric motor.

17. The poultry conveying system of claim 1, further comprising a holding system connected to the first actuator and a holding system connected to the second actuator, wherein each of the holding systems are configured to be selectively moveable between a first mode and a second mode, wherein in the first mode, the holding systems are configured to substantially prevent the first actuator and the second actuator from actuating, and wherein in the second mode, the holding systems are configured to allow the first actuator and the second actuator to actuate.

18. (canceled)

19. The poultry conveying system of claim 17, wherein the first actuator is configured for actuating the rotation of the mandrel around the first and second axes when the holding system of the second actuator is in the second mode and/or wherein the second actuator is arranged for actuating the rotation of the mandrel around the first and second axis when the holding system of the first actuator is in the second mode.

20. The poultry conveying system of claim 17, wherein each holding system is configured to be locked in the first mode by application of a locking force, and unlocked from the first mode by application of an unlocking force.

21. The poultry conveying system of claim 20, further comprising a first guiding rail configured to apply the unlocking force and a second guiding rail configured to apply the locking force.

22. The poultry conveying system of claim 17, further comprising one or more rotation pins configured to actuate the first and second actuators from a first predetermined position to a second predetermined position.

23. The poultry conveying system of claim 17, wherein each holding system is biased toward the first mode.

24. The poultry conveying system of claim 1, wherein the mandrel includes a carcass retainer configured to substantially maintain the poultry carcass or a part thereof on the mandrel.

25. The poultry conveying system of claim 1, wherein the endless conveyor comprises an articulated endless conveyor.

26. A poultry processing apparatus including the poultry conveying system of claim 1; and one or more processing stations arranged adjacent to the poultry conveying system and configured for cutting, skinning, deboning, harvesting, or a combination thereof, the poultry carcass or part thereof.

27. A method for conveying a poultry carcass or a part thereof, comprising:
placing the poultry carcass or a part thereof on a mandrel connected to a connection block of a conveying system by an intermediate section;
rotating the mandrel around a first axis relative to the intermediate section by actuating a first actuator located adjacent to the connection block; and
rotating the mandrel around a second axis relative to the intermediate section by actuating a second actuator located adjacent to the connection block.

28. The method of claim 27, wherein actuating the first actuator includes rotating the first actuator about a first actuation axis, and wherein actuating the second actuator includes rotating the second actuator about a second actuation axis.

29. The method of claim 27 wherein rotating the mandrel around the first axis by comprises moving a first relay element of the intermediate section, and wherein rotating the mandrel around the second axis comprises moving a second relay element of the intermediate section.

30. (canceled)

31. (canceled)

32. (canceled)

33. The method of claim 27, further comprising selectively moving a holding system for the first actuator and/or the second actuator between a first mode and a second mode, wherein in the first mode, the holding system substantially prevents activation of the first actuator and/or the second actuator, and in the second mode, the holding system allows the first actuator and/or the second actuator to actuate.

34. The method of claim 33, further comprising selectively locking the holding system in a first mode by application of a locking force, and selectively unlocking the holding system by application of an unlocking force.

35. The method of claim 27, further comprising: conveying the poultry carcass or part thereof past one or more processing stations arranged adjacent to the conveying system and configured for cutting, skinning, deboning, harvesting, or a combination thereof, the poultry carcass or part thereof.
